(19) United States
(12) Patent Application Publication
(10) Pub. No.: US 2007/0068475 A1
(43) Pub. Date: Mar. 29, 2007

(54) Internal combustion engine with a laser light generating device

(76) Inventors: Herbert Kopecek, Hallbergmoos (DE); Kurt Iskra, Kumberg (AT); Martin Weinrotter, Vocklabruck (AT); Josef Graf, Grosspetersdorf (AT); Johann Klausner, St. Jakob i.H. (AT)

Correspondence Address: WENDEROTH, LIND & PONACK, L.L.P., 2033 K STREET N. W., SUITE 800, WASHINGTON, DC, 20006-1021, US

(21) Appl. No.: 11/524,442

(22) Filed: Sep. 21, 2006

(30) Foreign Application Priority Data
Sep. 22, 2005 (AT) A 1559/2005

(51) Int. Cl. F02B 19/00; F02B 1/12; F02P 23/00; F02B 5/02; H01T 13/54

(52) U.S. Cl. 123/143 B; 123/143 R

(57) ABSTRACT

An internal combustion engine has a laser light generating device. The laser light generating device is suitable for delivering laser light with a transverse mode structure which varies in respect of time.

The present invention concerns an internal combustion engine with a laser light generating device.

Conventional laser light generating devices which are used in the area of laser ignition for internal combustion engines generally have a laser resonator which is so designed that the laser light delivered by the laser light generating device has a Gaussian profile (TEM₀₀-mode structure), that is to say, the intensity distribution falls transversely in an exponential configuration. Furthermore laser light generating devices with an unstable laser resonator are frequently also used in particular in relation to pulsed lasers. That resonator concept also involves a transversely varying intensity distribution over the beam cross-section.

A serious obstacle in regard to use of laser-ignited internal combustion engines, which is suitable for large-scale use, lies in the low level of efficiency with which the laser light is introduced into the plasma volume which is to be heated up for reliable ignition of the fuel-air mixture. Those losses result on the one hand from the transmission losses of the laser radiation which passes through the ignition volume prior to the laser-induced plasma breakdown, and on the other hand from losses which are caused by the laser radiation laterally passing the plasma volume by virtue of an excessively small plasma size or a focus geometry which is laterally excessively far extended.

The object of the invention is to further develop an internal combustion engine of the general kind set forth, in such a way that the level of efficiency with which the laser light is used for ignition is increased.

That object is attained by an internal combustion engine having the features of claim 1.

With an internal combustion engine of that kind it is possible for the minimum energy necessary to produce a plasma core to be introduced into the combustion chamber by laser radiation which has a TEM₀₀-mode structure. That laser radiation has ideal focusing properties.

Furthermore the total energy necessary to produce an ignitable flame core is introduced into the combustion chamber in the form of a higher-energy laser light which is later formed, with a mode structure of higher transverse order. That occurs only when producing a sufficiently large plasma volume so that losses from radiation which passes the plasma beforehand in respect of time or laterally in respect of space are accordingly minimised.

In accordance with this disclosure the term transverse mode structure is used to denote the intensity pattern of an electromagnetic beam in a plane perpendicularly (that is to say transversely) with respect to the direction of propagation of the beam. The mode structures which can be produced by a laser resonator are of the transverse electromagnetic type (TEM).

The structure of the TEM modes is different depending on the respective symmetry of the laser resonator.

The TEM₀₀-mode is the fundamental mode with a Gaussian profile.

Preferably both the laser light with a TEM₀₀-mode structure and also the laser light having a mode structure of higher transverse order are delivered in the form of pulses.

Preferably both the laser light with a TEM₀₀-mode structure and also the laser light having a mode structure of higher transverse order are generated with the same laser light generating device. For that purpose it is necessary to provide that the laser light generating device has a laser resonator which is so designed that it can be operated stably in relation to at least two modes of different transverse order of the laser light which can be delivered.

Preferably a laser resonator of Fabry-Perot type is used in the invention.

The designation ‘transverse’ relates to any direction in right-angled relationship with the optical axis of the laser resonator.

It is known from the literature that, in the case of laser systems with passive quality switching by means of saturatable absorbers a sequential succession in respect of the production of different mode structures can occur (R Wu, T L Chen, J D Myers, M J Myers, C Hardy, Multi-Pulses Behavior in an Erbium Glass laser Q Switched by Cobalt Spinal, AeroSense 2003, SPIE Vol 5086, Orlando, Fla., Apr. 21-25, 2003).

That however involves unplanned effects which occur in a different mode structure and with an unintentional temporal sequence and the marketness of which moreover is not optimised to that for the production and post-heating of a laser-induced ignitable plasma.

For the preferred embodiment of the invention there is proposed a laser light generating device whose configuration of the laser resonator permits variability in respect of the stability condition of the laser resonator, by virtue of a suitable configuration of the optical surfaces. In that respect it is provided that the optical surfaces of the laser resonator are of such a configuration and are arranged relative to each other such that the beam diameter of a light beam introduced into the laser resonator is variable. Such a laser resonator is also known by the term ‘telescope resonator’.

A laser medium and a passive saturatable absorber are arranged in the laser resonator of such a laser light generating device, wherein preferably a respective surface of the laser medium and the absorber are of such a configuration and arrangement that they form a mirror of the laser resonator. In quite general terms it can be provided that the optical surfaces of the laser resonator are formed by the surfaces of the laser medium and the absorber.

It will be appreciated that alternatively it is also possible to provide a separate optical system, in particular separate mirrors.

In that respect the configuration of the surfaces of the active laser medium and/or the passive saturatable absorber in the preferred embodiment has on the one hand the function of determining the geometrical variability of mode production, which is necessary for the stability to be set for the laser resonator.

On the other hand, transverse variability of the passive saturatable absorber is to be guaranteed to the effect that reliable production of a TEM₀₀-mode can take place in a first step. Then, with a delay corresponding to the time development of the plasma core, a higher-energy radiation with a mode structure of higher transverse order can be generated, with the purpose of ensuring increased heating of the plasma to the temperatures necessary for reliable ignition of a fuel-air mixture, by more efficiently coupling in the laser light and avoidance of temporal or spatial passage losses.

The production of sequential pulses by the build-up of different modes and the different temporal behavior, resulting therefrom, of the saturatable absorber, aims specifically at first deliberately exciting the production of the TEM₀₀-mode necessary for ideal focusability, in order to ensure plasma formation at the laser focus. Thereafter modes of higher order are to be deliberately excited for production thereof in order to permit further heating of the plasma which has already formed. In that respect the production of modes of higher transverse orders additionally permits more efficient utilisation of the overall volume of the active laser medium.

For optimum utilisation of the laser energy of the following pulses the time spacing (delay), reckoned between the end of the preceding pulse and the beginning of the following pulse, should be between the pulses 100 ns-200 ns (nanoseconds), preferably 30 ns-70 ns. Within that delay the radiation of the subsequent pulses couples efficiently to the existing plasma of the preceding pulse without itself having to reach the high threshold intensity necessary for plasma formation. Therefore even poorly focusable transverse modes of higher order can also contribute to plasma heating. In the case of longer delays of over 200 ns the plasma has cooled down to such an extent that the laser radiation no longer couples and passes through the resulting hot gas volume, without plasma formation. In that case the threshold intensity necessary for plasma formation is even higher than in the normal situation.

The specific production of the TEM₀₀-mode can be achieved in the preferred embodiment (telescope resonator) by the structural measures set forth hereinafter.

By virtue of the provision of the curved surfaces of the laser medium and the saturatable absorber, a beam path is forced to occur in the laser resonator, which is suitable for altering the stability condition of the radiation circulating in the laser resonator. That is achieved by suitable selection of the values for the curvature and the spacing of the optical surfaces which form the telescope. In that respect the stability of the laser resonator is to be so adjusted that the production of radiation in higher transverse modes is not suppressed, but the configuration in principle of the laser resonator in the form of a hemispherically stable resonator allows the production of a TEM₀₀-mode.

In order to achieve the production of the TEM₀₀-mode specifically prior to the production of a mode structure of higher transverse order, modifications can be made to the laser medium (modulation of amplification) and/or the saturatable absorber (modulation of the losses):

In an embodiment the laser medium is such that, by virtue of a variation in the concentration of the laser-active materials, the absorption of the pump radiation produces an excitation energy distribution in such a way that excitation both of the TEM₀₀-fundamental mode and also modes of higher transverse order is guaranteed. Consequently the geometry of the laser resonator is to be so designed that the production both of the TEM₀₀-fundamental mode and also modes of higher transverse order is guaranteed.

In a further embodiment the saturatable absorber is designed in such a way that the initial transmission in the regions which are covered by the TEM₀₀-mode is kept higher than in the regions which are passed through in the production of modes of higher transverse order. The increased initial transmission in those spatial regions can be achieved by virtue of a special design for the saturatable absorber, such as for example by a reduction in the optical path length in the saturatable absorber or by a reduction in the concentration of the doping ions, which are necessary for the saturatable absorber to function, in the form of a gradient profile. That achieves a respective saturation intensity for the absorber, which varies in the transverse direction.

A simplified possible way of altering the effective cross-section in the absorber along the radial co-ordinate—that is to say in the transverse direction—is achieved by fitting into each other saturatable absorbers with differing doping (step profile). Laser modes which are propagated in the outer region of the absorber consequently pass through spatial regions of different saturation intensity and therefore start to oscillate in time-displaced relationship.

In order to adjust the time delay of the delivery of the laser light with a differing mode structure, preferably between the pulses, to a spacing which is necessary for reliable ignition, it may be necessary for the build-up characteristics of the modes of higher transverse order to be specifically controlled in respect of time. If therefore the TEM₀₀-mode should start to oscillate excessively early in comparison with higher modes, the production of the modes of higher transverse order is also to be made possible, by virtue of modulation of the amplification or loss cross-sections, in the direction of easier build-up relative to the TEM₀₀-mode. Depending on the respective pump geometry and excitation energy distribution in the laser medium it may therefore be necessary to increase the loss mechanisms in the saturatable absorber for the TEM₀₀-mode. That is appropriately effected by prolonging the optical path in the saturatable absorber or by a higher level of concentration of the absorber ions at the center with a constant geometry.

A further possible way of definedly exciting the production of time-displaced laser radiation with differing transverse mode structure involves the use of in particular radially or transversely differing levels of reflectivity of the coupling-out mirror. Such mirrors are used in laboratory lasers with what are referred to as unstable resonators. They have a radially varying reflectivity in order to stimulate build-up of the laser along the optical axis. Variants with a different reflectivity variation and on a curvature designed as a stable resonator are suitable in principle for the production of multiple pulses and can be produced more easily in accordance with the state of the art than non-homogeneous doping properties of the crystals.

When involving homogeneously doped laser crystals and saturatable absorbers of uniform thickness as well as coupling-out mirrors which are coated evenly with a constant reflectivity it is also possible to achieve multiple pulse production by the non-homogeneous distribution of the pump light. Passively quality-switched lasers with stable resonators have a tendency just to produce the TEM₀₀-mode or simultaneous build-up of a plurality of transverse modes. In order to guarantee the production of time-displaced modes of higher order, the pump light distribution can be non-homogeneous in such a way that, by virtue of the use of suitable optical elements in the beam path of the pump laser, only the energy necessary to build up the TEM₀₀-mode is coupled in along the optical axis, but an increased proportion of the pump energy is distributed into the volume of higher transverse modes. In principle that additional optical system also allows controlled distribution of the pump energy and affords a possible way of controlling the time spacing of the pulses. Alternatively non-homogeneous light distribution could also be afforded by a plurality of pump light guide fibers or pump light sources which light to varying degrees. It will be appreciated that a combination of various ones of the above-indicated measures can also be used for producing the laser light with a transverse mode structure which changes in respect of time.

A great advantage of the variant of the laser light generating device in which the laser light is delivered pulse-wise is that firstly the efficiency of utilisation of the laser energy is markedly increased by multiple pulse production (a short, well-focusable pulse for laser generation is followed by a second pulse in order to increase the energy content of the laser or at least to maintain it over a longer period of time) and secondly by virtue of the spatially different propagation or form of the laser modes the plasma is to be markedly enlarged in its volume, which is of advantage in particular in terms of the ignition of lean mixtures.

In addition a laser of that kind can have a positive influence on the unwanted effect of deposits at the combustion chamber window used as the energy density at the window is distributed to two or more pulses.

By way of example laser light which in time sequence has a TEM₀₀-mode structure and a TEM_{p=0, l=8}-mode structure could be introduced into the combustion chamber of the internal combustion engine. Light with a TEM_{p=0, l=8}-mode structure has approximately the structure of a hollow cylinder, wherein there are tangentially a plurality of zero locations.

Protection is also claimed for a method of igniting a fuel-air mixture in the combustion chamber of an internal combustion engine, in particular according to one of claims 1 through 11, by the laser light delivered by a laser light generating device, wherein the transverse mode structure of the laser light is varied in respect of time.

By way of example with a method of that kind it can be provided that firstly to produce a plasma in the fuel-air mixture laser light with a TEM₀₀-mode structure is introduced into the combustion chamber and then to post-heat the plasma laser light with a mode structure of higher transverse order is introduced into the combustion chamber.

Further advantages and details of the invention will be apparent from the Figures hereinafter and the related specific description in which:

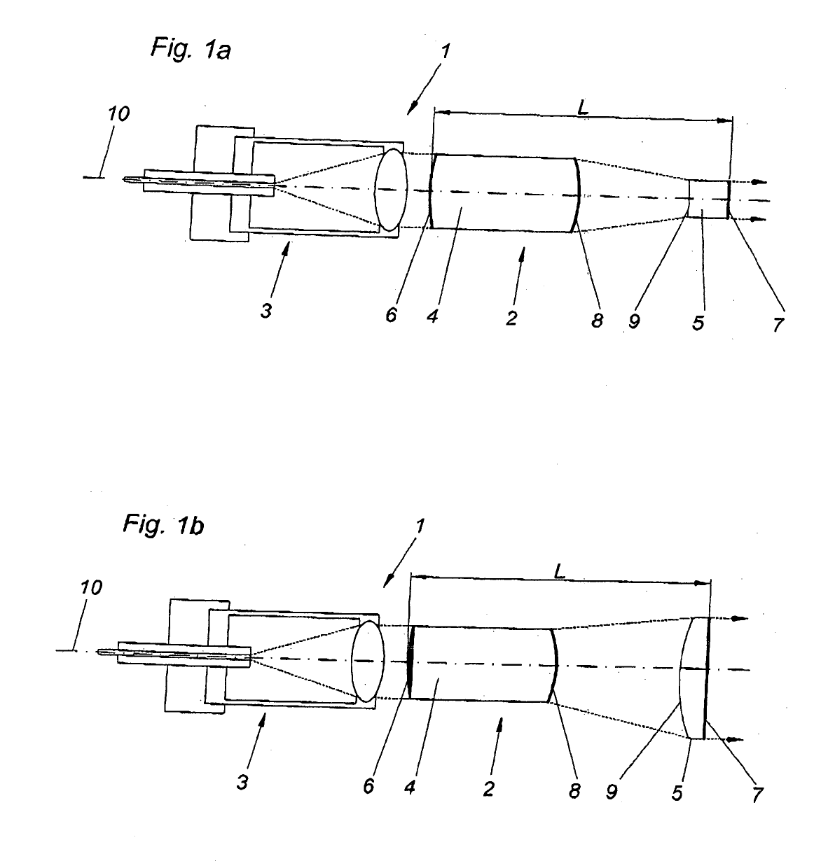

FIGS. 1a and 1b show two different embodiments of the laser resonator which is to be used in an internal combustion engine according to the invention,

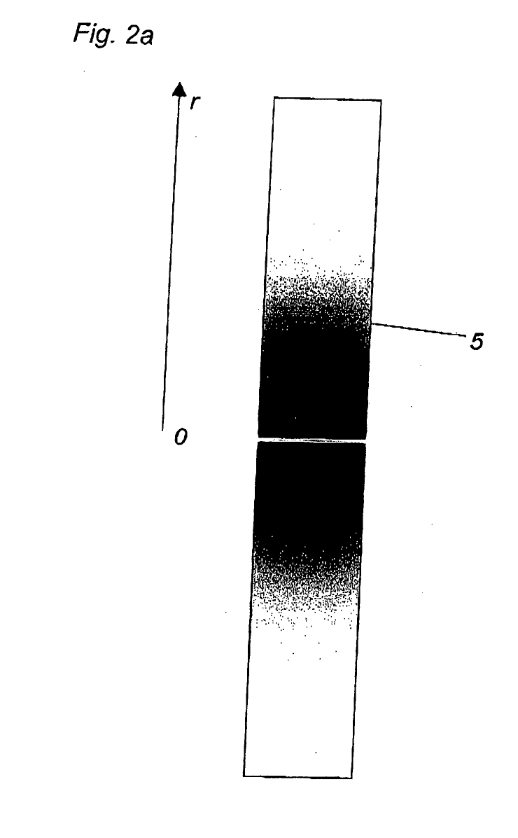

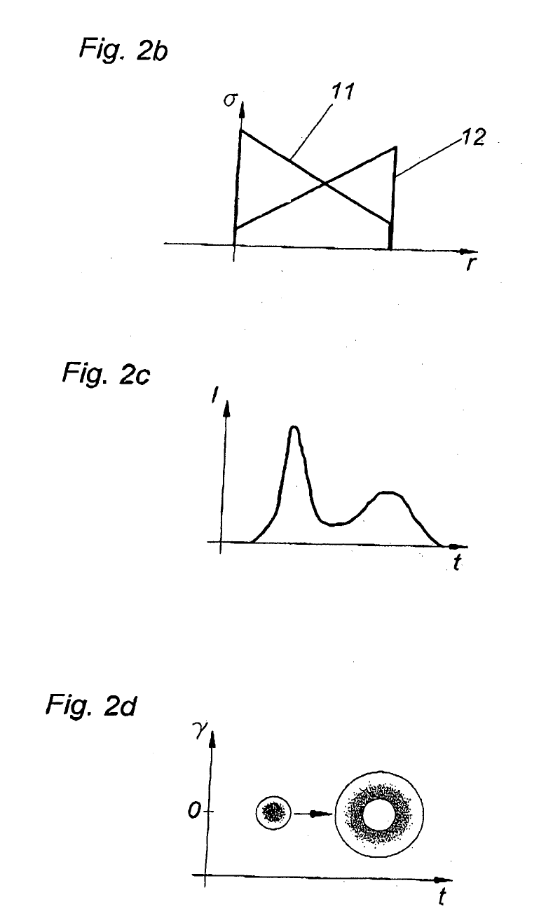

FIGS. 2a-d show diagrammatic views of a saturatable absorber, the operative cross-section of the absorber in a transverse direction, the intensity of the delivered laser light in dependence on time and the spatial structure of the delivered laser light in dependence on time,

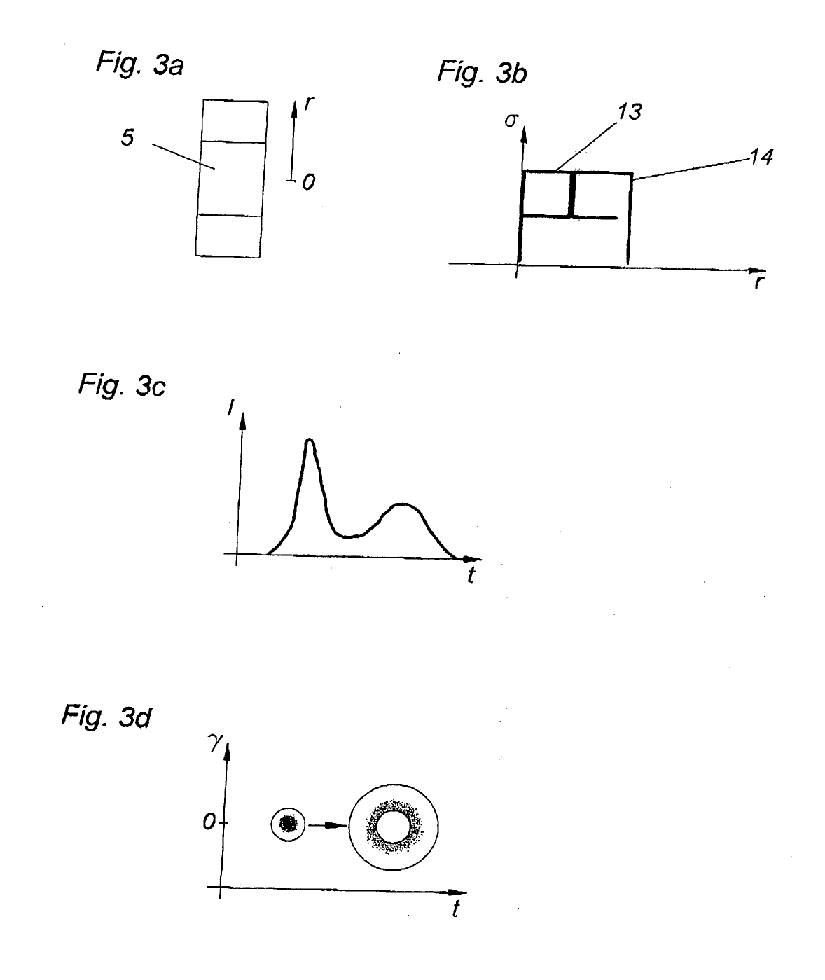

FIGS. 3a-d show diagrammatic views of a saturatable absorber, the operative cross-section of the absorber in a transverse direction, the intensity of the delivered laser light in dependence on time and the spatial structure of the delivered laser light in dependence on time, for a further embodiment of an absorber,

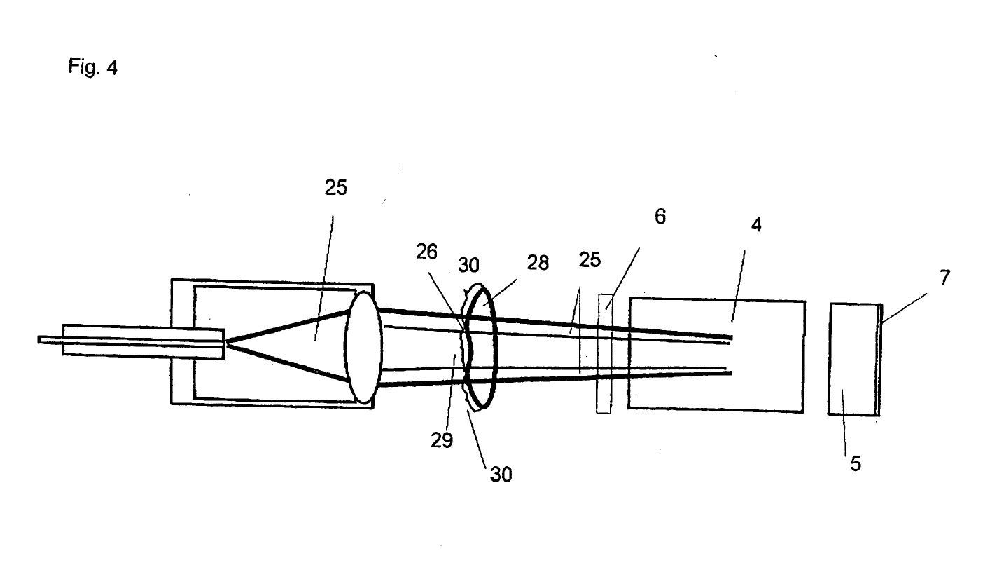

FIG. 4 shows an embodiment with correction optical system for influencing the pump light distribution in such a way that for modes of higher order sufficient pump light energy is available to reach the laser threshold,

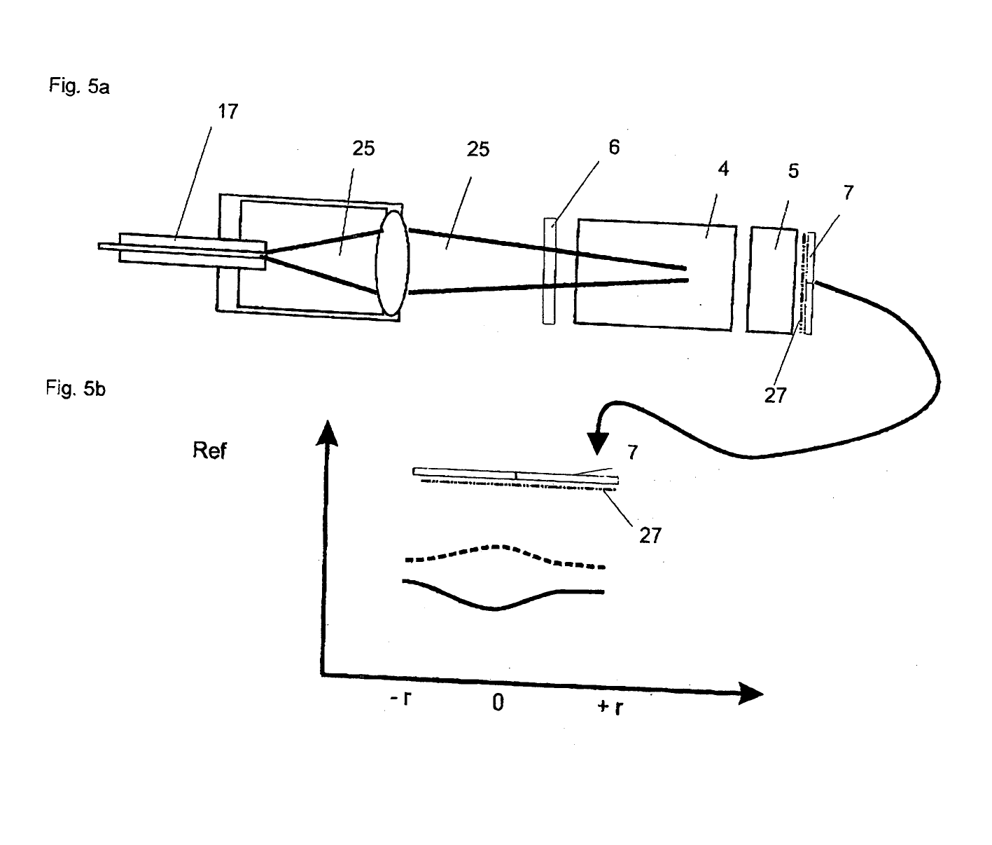

FIG. 5a shows a variant in which the reflectivity of the surface coating of the output mirror is varied in such a way that both pump light distribution and also laser threshold permit multiple pulse production,

FIG. 5b shows a view relating to the varying reflectivity of the surface coating of FIG. 5a, and

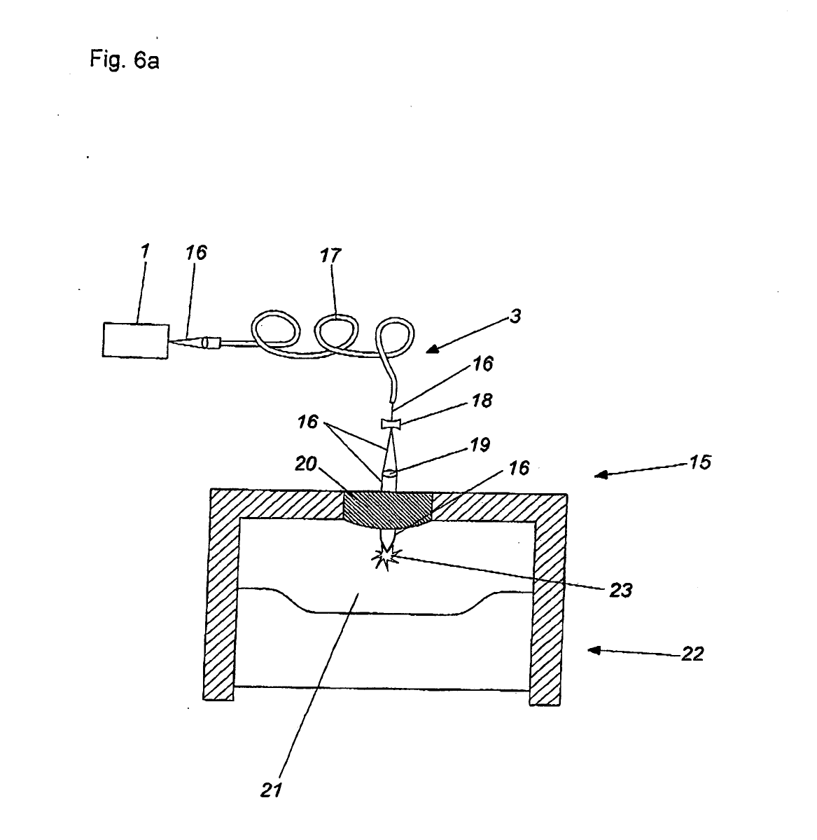

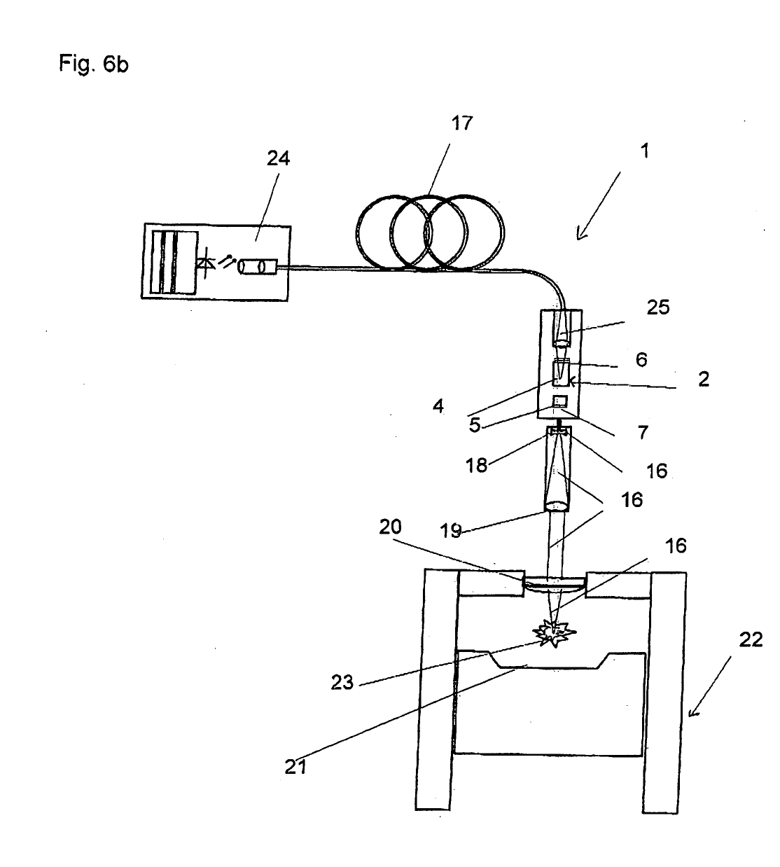

FIGS. 6a and 6b show embodiments of an internal combustion engine according to the invention.

FIG. 1a shows an embodiment of a laser light generating device 1 according to the invention including a laser resonator 2 of the length L and a coupling-in optical system 3 for the radiation of a pump laser (not shown in FIG. 1). The laser resonator 2 has a laser medium 4 and a passive saturatable absorber 5. The optical surfaces of the laser resonator 2 are formed by surfaces of the laser medium 4 and the absorber 5. Thus the surfaces 6 and 7 form the mirrors of the laser resonator 2. The surfaces 8 and 9 are such as to give the beam path of a telescope which in FIG. 1a is linked to a reduction in the beam diameter and in FIG. 1b to an enlargement in the beam diameter.

In FIG. 1a the laser medium 4 is homogeneously pumped by radiation which is coupled in by way of the coupling-in optical system 3. The passive saturatable absorber 5 is homogeneously doped. In that respect the absorber 5 is of such a configuration in a transverse direction that the optical path length increases with increasing distance from the optical axis 10. In other words the passive saturatable absorber 5 has more substance with increasing distance from the optical axis 10. The result of this is that earlier breakdown occurs in the region of the optical axis 10 in which the TEM₀₀-mode is located. In contrast later breakdown occurs in the outer regions of the saturatable absorber 5 in which the modes of higher transverse order are located. The overall result of this is that a first pulse with a TEM₀₀-mode structure and a second pulse with a mode structure of higher transverse order are delivered in temporal succession by the laser light generating device 1.

The laser light generating device 1 shown in FIG. 1b differs from the laser light generating device 1 shown in FIG. 1a in that on the one hand the surfaces 8 and 9 are so designed that an enlargement of the beam diameter occurs and on the other hand the passive saturatable absorber 5 is so designed that there is a reduction in the optical path length with increasing distance from the optical axis 10. In other words the passive saturable absorber 5 has less substance with increasing distance from the optical axis 10. That measure was undertaken in order to achieve a time delay in the build-up of the TEM₀₀-mode in order to reduce the time spacing between the first pulse with a TEM₀₀-mode structure and the second pulse with a mode structure of higher transverse order.

As an alternative to the measure of a homogeneously doped passive absorber 5 as adopted in FIGS. 1a and 1b, it is also possible to use absorbers 5 which have a doping which varies in the transverse direction. Absorbers of that kind are shown in FIGS. 2a and 3a.

In FIG. 2a the ion concentration of the saturatable absorber 5 is of a falling configuration with increasing distance r in a first embodiment (curve 11 in FIG. 2b) and of a rising configuration in a second embodiment (curve 12 in FIG. 2b). The resulting intensity or spatial configuration of the laser radiation delivered is shown in FIGS. 2c and 2d.

In FIG. 3a a step profile was selected in the ion concentration of the saturatable absorber 5. So-to-speak two homogeneously doped materials were fitted into each other. In that respect in a first embodiment an ion concentration which is higher at the center of the absorber 5 (curve 13 in FIG. 3b) was selected. In contrast thereto, a second embodiment involved selecting a lower ion concentration (curve 14 in FIG. 3b). The resulting intensity or spatial configuration of the laser radiation delivered is shown in FIGS. 3c and 3d.

FIG. 4 shows a variant in terms of pump light coupling-in in which a lens or correction optical system 28 with additional grinding 26 alters the pump light distribution 25 in such a way that the otherwise typical intensity peak at the center is reduced to the benefit of the radially further outwardly disposed components which are coupled into spatial regions of higher transverse modes. Different alternative configurations of the correction optical system are possible in that case. In the illustrated form the lens 28 has a beam-enlarging action in the central region 29 and a focusing action in the edge regions 30 so that the pump light 25 is in effect concentrated more strongly on the outer regions of the laser medium 4.

FIG. 5a shows that different reflectivity in respect of the coating 27 of the coupling-out mirror 7 of the laser light generating device 1 can be so selected that different laser thresholds occur in spatially different regions of the resonator.

FIG. 5b shows how, depending on the respective distribution of the intensity of the pump light, a reduction (broken line) or an increase (solid line) in the degree of reflection (Ref) can be necessary at the edge (−r, +r) with respect to the optical axis (o) in order to permit time-displaced build-up of the laser. The radially varying reflectivity (Ref) of the coupling-out mirror 7 can naturally also be produced in some other way, apart from a coating 27.

FIG. 6a shows an internal combustion engine 15 with a laser light generating device 1 according to the invention. The laser light 16 delivered by the laser light generating device 1 is introduced into the combustion chamber 21 of a cylinder 22 by way of a light guide 17, an enlargement optical system formed by the lenses 18 and 19 and a combustion chamber window 20. In that arrangement the combustion chamber window 20 is of such a configuration that the laser light 10 is focused on the focus volume 23 in the combustion chamber 21.

The variant shown in FIG. 6b differs from that shown in FIG. 6a insofar as FIG. 6b provides a pump light source 24 which by way of the light guide 17 couples the pump laser radiation 25 generated thereby into the laser resonator 2 having the laser medium 4, the absorber 5 and the mirrors 6 and 7. The laser resonator can be designed as shown in FIGS. 1 through 5b.

1. An internal combustion engine having a laser light generating device characterised in that the laser light generating device is so designed that it is suitable for delivering laser light with a transverse mode structure which varies in respect of time.

2. An internal combustion engine as set forth in claim 1 having a combustion chamber into which a fuel-air mixture can be introduced, characterised in that the laser light generating device is so designed that it is suitable for delivering laser light which in temporal succession has a TEM₀₀-mode structure and a mode structure of higher transverse order, wherein the laser light having a TEM₀₀-mode structure is adapted to generate a laser-induced plasma in the fuel-air mixture and wherein the laser light having a mode structure of higher transverse order is adapted to post-heat the plasma.

3. An internal combustion engine as set forth in claim 1 characterised in that the laser light generating device has a laser resonator which is so designed that it can be stably operated in relation to at least two modes of different transverse order of the laser light which can be delivered.

4. An internal combustion engine as set forth in claim 3 characterised in that the optical surfaces of the laser resonator are of such a configuration and are so arranged relative to each other that the beam diameter of a light beam introduced into the laser resonator is variable.

5. An internal combustion engine as set forth in claim 3 characterised in that a laser medium and a passive saturatable absorber are arranged in the laser resonator.

6. An internal combustion engine as set forth in claim 5 characterised in that a respective surface of the laser medium and of the absorber are of such a configuration and arrangement that it forms a mirror of the laser resonator.

7. An internal combustion engine as set forth in claim 5 characterised in that the optical surfaces of the laser resonator are formed by the surfaces of the laser medium and the absorber.

8. An internal combustion engine as set forth in claim 5 characterised in that the saturatable absorber is of such a configuration that it has a varying saturation intensity in the transverse direction.

9. An internal combustion engine as set forth in claim 8 characterised in that the saturatable absorber is of such a configuration that it has at least two regions of differing saturation intensity in the transverse direction.

10. An internal combustion engine as set forth in claim 8 characterised in that the saturatable absorber has a varying optical path length in the transverse direction.

11. An internal combustion engine as set forth in claim 8 characterised in that the saturatable absorber has a varying doping in the transverse direction.

12. An internal combustion engine as set forth in claim 3 characterised in that the laser light generating device is suitable for coupling pump laser radiation with a transversely non-homogeneous intensity distribution into the laser resonator.

13. An internal combustion engine as set forth in claim 12 characterised in that the laser light generating device has a correction optical system for coupling the transversely non-homogeneous intensity distribution into the laser resonator.

14. An internal combustion engine as set forth in claim 3 characterised in that the laser resonator has a mirror with transversely non-homogeneous reflectivity.

15. An internal combustion engine as set forth in claim 1 characterised in that the laser light generating device is suitable for delivering at least two laser light pulses with differing transverse mode structure, wherein a time spacing of between 10 ns and 200 ns or between 30 ns and 70 ns is provided between two successive laser light pulses.

16. A laser light generating device for an internal combustion engine as set forth in claim 1.

17. A method of igniting a fuel-air mixture in the combustion chamber of an internal combustion engine by laser light delivered by a laser light generating device characterised in that the transverse mode structure of the laser light is varied in respect of time.

18. A method as set forth in claim 16 characterised in that firstly laser light with a TEM₀₀-mode structure is introduced into the combustion chamber to produce a plasma in the fuel-air mixture and then laser light with a mode structure of higher transverse order is introduced into the combustion chamber for post-heating of the plasma.
